(19) United States
(12) Patent Application Publication
(10) Pub. No.: US 2014/0106049 A1
(43) Pub. Date: Apr. 17, 2014

(54) HIGH PROTEIN SNACK CHIPS AND METHODS FOR PREPARING THE SAME

(71) Applicant: Meat Chips, LLC, Tempe, AZ (US)

(72) Inventor: Daniel T. Fillmore, Tempe, AZ (US)

(73) Assignee: Meat Chips, LLC, Tempe, AZ (US)

(21) Appl. No.: 14/107,870

(22) Filed: Dec. 16, 2013

Related U.S. Application Data
(63) Continuation-in-part of application No. 13/659,762, filed on Oct. 24, 2012.
Application No. 13/659,762 is a continuation of application No. 12/610,110, filed on Oct. 30, 2009, now abandoned.
(60) Provisional application No. 61/110,451, filed on Oct. 31, 2008.

(51) Int. Cl. A23L 1/164; A23L 1/217

(52) U.S. Cl. CPC A23L 1/1645; A23L 1/2175
USPC 426/550; 426/560; 426/466; 426/439; 426/438

(57) ABSTRACT

The present disclosure describes high protein snack chips comprising meat, seafood and/or poultry powder that adds animal-sourced protein and/or flavors without entraining problematic moisture in precursor dough used to make the chips. The present disclosure also encompasses methods for producing high protein snack chips comprising the steps of making dough comprising meat, seafood and/or poultry powder along with various dry, wet and, optionally, fat ingredients, sheeting the dough, optionally baking the sheeted dough, cutting the uncooked or baked sheeted dough into pieces, and baking and/or frying the pieces to produce tasty, reduced fat, crispy, crunchy snack chips.

### CROSS-REFERENCE TO RELATED APPLICATIONS

This application is a Continuation-In-Part of U.S. patent application Ser. No. 13/659,762 filed Oct. 24, 2012, which is a Continuation of U.S. non-provisional patent application Ser. No. 12/610,110, now abandoned, filed Oct. 30, 2009, which claims priority to U.S. Provisional Patent Application Ser. No. 61/110,451 filed Oct. 31, 2008, which are incorporated herein by reference in their entirety.

### FIELD OF THE INVENTION

The present disclosure relates generally to snack foods and in particular to high protein crispy snack chips and methods for preparing the same.

### BACKGROUND OF THE INVENTION

Baked and/or fried snack foods, such as potato chips, corn chips, tortilla chips, pretzels, crackers, and the like, have enjoyed wide popularity fir a long time. Chips such as these are disclosed, for example, in U.S. Pat. Nos. 5,690,982; 5,500,240; 4,973,481; 4,283,425: 3,835,222; 3,545,979; 3,230,094; and 2,916,378.

Snack chips are typically packed in hermetically sealed bags, with net weights of about 50-500 grams. The sealed bags can be opened by hand anywhere and the chips enjoyed as a snack product without heating or any other preparations. Optionally, snack chips can be eaten with added seasoning or after dipping in a chip dip or salsa.

Potato chips can be prepared by thinly slicing potatoes and then deep-frying the slices in hot oil at temperatures between 160-220° C. Other root vegetables can be milady converted into snack chips. However, frying potatoes and other root vegetable slices in this manner can result in a fairly large amount of fat retained in the chips. For example, fried potato chips can have up to about 35% by weight of fat content.

Snack chips pan also be made from potato starch and/or corn starch or other starch-based dough that can be baked rather than fried to reduce fat content. However, taste is often compromised when attempting to reduce fat content in chips by only baking rather than frying. Some snack chips, such as restaurant-style tortilla chips, can be prepared by first sheeting and baking dough into tortillas, and then cutting the baked tortillas into pieces of desired shape and deep-frying the pieces to make tortilla chips.

Snack chips may be salted, seasoned and/or flavored as desired to follow particular brand strategies and generate appeal to certain demographic groups. Good quality snack chips tend to be dry, crispy and at least somewhat resistant to breakage during packaging, shipping and merchandizing.

In addition to the constant demand for variety in snack chip flavors and textures, consumers have recently become health conscious and are becoming reluctant to consume large amounts of fats in snack chips having nutritional contribution only from carbohydrates. Conventional potato chips generally have a low amount of protein and a high amount of fat and carbohydrate, making them unattractive to the health-conscious consumer.

Thus, there is an ongoing need to develop high protein, low fat snack chips, and the continuing need for innovative methods of preparing healthier snack chips.

### SUMMARY OF THE INVENTION

Various embodiments of the present disclosure generally comprise baked and/or fried snack chips that are high in animal, rather than vegetable, protein. In various embodiments, the snack chips in accordance with the present disclosure comprise powdered meat, seafood, and/or poultry, along with other components, such as rice or wheat flour, starches, corn, grains, seeds, and/or fats.

In various embodiments, meat, seafood, and/or poultry powder imparts various flavors to the snack chips of the present disclosure, in addition to increasing the protein level.

Various embodiments of the present disclosure also comprises methods for preparing high protein snack chips, with the methods generally comprising sheeting dough made from dry, wet, and optional fat components to a desired thickness, cutting the dough into individual pieces having a desired shape and size, and baking and/or frying the cut pieces into high protein crispy snack chips. In other embodiments, dough may be extruded, cut and flattened prior to baking and/or frying into chips. In other embodiments, dough comprising meat, seafood and/or poultry powder may be sheeted and baked into thin tortillas, then cut and fried into snack chips.

In various embodiments, dry dough components comprise various types of wheat, rice or corn flour or starches, grains, seeds, meat powder, seafood powder, poultry powder, yeast, starter, baking powder, baking soda, dough conditioners, flavorings, flavor enhancers, food colorings, preservatives, minerals, and the like, and mixtures thereof.

In various embodiments, wet dough components generally comprise water, milk, eggs, clarified butter, stock, liquors, juices, dough conditioners, liquid flavorings/extracts, liquid food colorings, liquid preservatives, and the like, and mixtures thereof

In various embodiments, wet dough components include, for example, chicken or turkey. To achieve targeted moisture content in the dough using wet chicken and/or turkey, additional dry dough components are used to compensate for the additional moisture. In various embodiments, processes such as add back or partial drying can be used to reduce the moisture content of the dough.

In various embodiments, the optional fat components comprise vegetable or animal fat, natural or modified. In various embodiments, the fat components are added to the dough during preparation of dough and/or the fat is incorporated into the finished snack chips during a baking and/or frying operation.

### BRIEF DESCRIPTION OF THE DRAWINGS

The accompanying drawings are included to provide a further understanding of the disclosure and are incorporated in and constitute a part of this specification, illustrate embodiments of the disclosure, and together with the description serve to explain the principles of the disclosure, wherein:

FIG. 1 illustrates an embodiment of a snack chip in accordance with the present disclosure;

FIG. 2 illustrates a side view of an embodiment of a snack chip in accordance with the present disclosure;

FIG. 3 illustrates an embodiment of a method of preparing snack chips in accordance with the present disclosure;

FIG. 4 illustrates a side view of an embodiment of a dough processor in accordance with the present disclosure;

FIG. 5 illustrates a perspective view of an embodiment of a dough processor in accordance with the present disclosure; and

FIG. 6 illustrates a side view of an embodiment of a furnace in accordance with the present disclosure.

### DETAILED DESCRIPTION OF THE INVENTION

The following description is of various exemplary embodiments only, and is not intended to limit the scope, applicability or configuration of the present disclosure in any way. Rather, the following description is intended to provide a convenient illustration for implementing various embodiments including the best mode. As will become apparent, various changes may be made in the function and arrangement of the elements described in these embodiments without departing from principles of the present disclosure.

As described in more detail herein, various embodiments of the present disclosure generally comprise crispy snack chips, (“snack chip”) and methods for preparing such snack chips.

In various embodiments, snack chips in accordance with the present disclosure comprise powdered meat, seafood and/or poultry that add animal-sourced protein and/or flavors to the snack chips without entraining problematic water into precursor dough used to make the snack chips. In other embodiments, turkey, chicken or other meat, seafood or poultry mash is incorporated into dough used to make high protein snack chips, wherein the moisture content of the dough is adjusted such that the dough is machinable.

Snack chips in accordance with the present disclosure are higher in protein than traditional starch-based chips and can thus serve as both a snack food and a protein supplement. In various embodiments, the snack chips of the present disclosure are lower in fat content than snack chips produced by the deep-frying of sliced root vegetables or deep-frying processed dough pieces. In various embodiments, the snack chips of the present disclosure are healthy snack alternatives to conventional potato chips or tortilla chips, yet can still provide similar marketable attributes of conventional potato chips. Other ingredients, such as for example, grains, seeds, vitamins and antioxidants can be included in the snack chips of the present disclosure to impart various health benefits, textures, appearances and tastes, and to distinguish over conventional potato chips.

In accordance with the present disclosure, methods for preparing high-protein snack chips generally comprise preparing dough having powdered meat, seafood, and/or poultry content, sheeting the dough, cutting the dough into pieces, and baking and/or frying the pieces to produce snack chips. In various embodiments, dough may be sheeted and baked prior to cutting and baking and/or frying to produce the chips. In various other embodiments, dough may be extruded and cut into portions that are flattened and baked and/or fried to produce crispy snack chips.

As used herein, the term “snack chip” refers to a baked and/or fried crispy, edible food snack configured in a shape, thickness and size convenient for consumption and enjoyment. Snack chips may be savory and/or sweet, and may include any number of flavorings. Examples of retail snack chips include Lays® potato chips, Fritos® corn chips, and Doritos® tortilla chips. Snack chips may be prepared, for example, by frying or baking a sliced root vegetable, or by frying and/or baking dough or other food paste having dough-like consistency. The thickness of snack chips in general may be chosen to optimize a number of attributes, such as for example, crispiness, taste, mouth feel and resistance to breakage while in the package.

As used herein, the term “jerky” refers to dehydrated meat, such as for example, beef, pork or turkey, usually marketed in flat chewy strips or chunks. These snacks generally comprise dried meat flesh with added flavorings such as smoke, teriyaki or barbeque. Meat jerky, although a type of high-protein snack food per se, is not within the scope of the presently defined term “snack chip” and is outside the scope of the present disclosure.

As used herein, the term “dough” broadly refers to a thick, malleable paste comprising any type and ratio of dry and liquid ingredients, which can be baked and/or fried into a food item, such as for example, a snack chip. Dough, as referred to herein, includes bread-type dough common to the baking profession, along with any other paste or batter having a consistency suitable for rolling and/or flattening and baking and/or frying into snack chips. Dough, as referenced herein, also encompasses corn masa, (i.e. masa de maiz), which is ground hominy corn (posole) worked into a paste having dough-like consistency. Dough, as used herein, may be leavened or unleavened, and may comprise other ingredients such as, for example, fat, salt, and sugar.

As used herein, the term “meat” broadly refers to the edible parts of any domestic or wild land animal, such as, for example, cattle, swine, lamb, sheep, goat, horse, buffalo, bison, deer, reindeer, moose, elk and snake, amongst other animals. Edible parts may include, but are not limited to, one or more of: flesh, organs, cartilage and bone. Typical meats include, for example, beef, veal, lamb, pork, venison and lamb, amongst others. For use in preparing the snack chips of the present disclosure, meat ingredients may be in a dry or paste form.

As used herein, the term “seafood” broadly refers to the edible parts of any lake, stream, river, sea or ocean creature, farmed or wild, such as, but not limited to, fish, mollusks, crustaceans, anemone, urchin, and the like. Edible parts may include, but are not limited to, one or more of: flesh, organs, eggs (roe), cartilage, shell and bone. Typical seafood includes, for example, tuna, salmon, swordfish, mahi-mahi, shark, trout, bass, catfish, halibut, cod, haddock, flounder, mackerel, sole, red snapper, grouper, cuttlefish, bonito, herring, sardine, robin, squid, octopus, lobster, eel, crab, clams, shrimp, crawfish, salmon roe, and sea urchin roe, amongst others. For example, one commercially available blend of fish parts in powder or cake form is fishmeal. For use in preparing the snack chips of the present disclosure, seafood ingredients may be in a dry or paste form.

As used herein, the term “poultry” broadly refers to the edible parts of any domestic or wild bird, capable of flight or flightless, such as, but not limited to, chicken, turkey, duck, Cornish game hen, goose, ostrich, cassowary, emu, moa, swan, quail, pheasant, Guinea fowl, grouse, peacock, pigeon, sparrow, and the like. Edible portions may include, but are not limited to, one or more of: flesh, organs, cartilage and bone. Typical poultry includes, for example, chicken, turkey and duck. For use in preparing the snack chips of the present disclosure, poultry ingredients may be in a dry or paste form.

As used herein, the term “powdered” broadly refers to a dry, flowable physical form of an ingredient of the present snack chips, and is not meant to be limited to any common meaning A particular food ingredient may have been previously dried by any combination of heat, air, or freeze-drying. “Powdered,” as used in the present disclosure, broadly encompasses physical forms such as powders, granules, flakes and/or shavings. For example, a meat may be cooked, dried or freeze-dried, and then shaved into a fine material capable of flow. Additionally, bonito flakes, are a type of powdered seafood ingredient usable herein. In various embodiments, snack chips in accordance with the present disclosure comprise powdered meat, powdered seafood, and/or powdered poultry to enhance protein levels and/or add certain textures and/or flavors. Powdered meat, seafood and poultry used herein typically comprise less than about 5% by weight moisture, such that these powdered ingredients can be incorporated into dough as dry, rather than wet, dough components.

As used herein, the term “mash” refers to a paste comprising at least one food ingredient and water, stock, and/or fat. For example, turkey and chicken paste can be in the form of turkey mash and chicken mash, respectively, with each having a moisture content of approximately 80% by weight. Turkey, chicken and other meat, seafood and poultry mash can be incorporated into dough as wet, rather than dry, dough components. Similarly, cooked and mashed potatoes constitute wet dough ingredients for use herein.

In various embodiments, the snack chips in accordance with the present disclosure are formed from dough that is baked and/or fried to remove moisture from the dough and to cook dough pieces into crisp snack chips. In various embodiments, the dough comprises dry dough components, wet dough components, and optionally, fat components. Some food ingredients for use herein can be incorporated in dough either in the form of a wet dough component or a dry dough component, as desired.

In various embodiments, the snack chips of the present disclosure comprise various dry dough components totaling at least about 40% by weight of the snack chip. In other embodiments, the dry dough components may total at least about 60% by weight of the chip.

In various embodiments of the present disclosure, the dry dough components are chosen from the group consisting of flour, starch, grain, seeds, powdered meat, powdered seafood, powdered poultry, and mixtures thereof. In various embodiments, the dry dough components can be in the form of dust, powder, granulate, shavings and/or flakes, or for seeds not previously crushed or ground, in their naturally occurring form. In various embodiments, the dry dough components are chosen from the group consisting of potato, rice, corn, wheat, rye, barley, millet, oat, spelt, kamut, flax, acorn, peanut, almond, atta, amaranth, buckwheat, chia, Cassava, chestnut, chickpea, chuno, coconut, hemp, Maida, Pease meal, teff, sorghum, tapioca, quinoa, soybean, semolina, arrowroot, taro, cattail, manioc, garbanzo bean, mesquite bean, powdered milk, milk protein solids, poultry powder, seafood powder, meat powder, and the like, and mixtures thereof.

In various embodiments of the present disclosure, the dry dough components comprise commercial flour, such as for example, those flours selected from the group consisting of white (bleached) wheat flour, whole wheat flour, rice flour, corn flour, oat flour, mesquite bean flour, and mixtures thereof. These types of flour usually contain less than about 20% by weight moisture, less than about 15% by weight moisture for good storage capabilities, and usually adjusted to about 14% moisture basis. Wheat flour also generally comprises about 5-15% by weight protein and about 60-80% by weight carbohydrate. Commercial flours for use in the snack chips of the present disclosure may contain various flour additives, such as vitamins (“enriched” flour), oxidants, reducing agents, anti-caking additives and malt.

In various embodiments of the present disclosure, the dry dough components comprise commercial starches, such as for example, starches selected from the group consisting of potato starch, wheat starch, cornstarch, cassava starch, tapioca starch, sago starch, arrowroot starch, rice starch, and combinations thereof. Starch is typically prepared by extraction from stems, germ, seeds, roots, and/or tubers, with wet-grinding, washing, sieving and grinding as necessary to produce the particular starch powder.

In various embodiments of the present disclosure, the dry dough components comprise meat, seafood, and/or poultry powder. For example, the dry dough components may comprise powdered meat, fish and/or poultry obtained from the grinding, pulverizing, milling, shaving and/or flaking of cooked and dried, dehydrated and/or freeze-dried meat, seafood and/or poultry. Exemplary methods for preparing powdered meat, seafood and poultry, usable in the snack chips of the present disclosure, are disclosed in: U.S. Pat. No. 5,059,445 (Arsem; freeze-dried meat powder); U.S. Pat. No. 4,215,153 (Fumindo, et al; fish powder) (Kai, et. al); U.S. Pat. No. 3,959,517 (Hiroshi, et al; fish powder); U.S. Pat. No. 3,955,011 (Hiroshi, et al; fish powder); U.S. Pat. No. 3,922,372 (Hasegawa; fish powder); U.S. Pat. No. 1,536,308 (Remus; meat powder); U.S. Pat. No. 1,517,445 (MacLachlan, et al; meat powder). U.S. Pat. No. 1,372,527 (MacLachlan; meat powder); U.S. Pat. No. 1,005,539 (Grotkass; meat powder); U.S. Pat. No. 678,283 (Schaefer; fish powder); U.S. Pat. No. 658,248 (Dunn; meat powder). Meat, seafood and poultry powders, usable in the snack chips of the present disclosure, are available from Shanghai Hensin Industry Co., Ltd.; Tianjin Tangchao Foods Industry Co., Ltd.; Setalg (France); and Henningsen Foods, Omaha, Nebr., amongst others.

Meat, seafood and poultry powders for use in the snack chips of the present disclosure contain less than about 5% by weight moisture based on the total weight of the powdered meat, seafood or poultry ingredient. This relatively low moisture content allows the dough formation when meat, seafood, and/or poultry powder is/are combined with other dry dough components (e.g. one or more flours and/or starches) and wet dough components (e.g. water). In striking contrast, the use of meat, seafood or poultry paste, which can contain about 80% by weight water based on the weight of the paste, retards formation of workable dough that can be sheeted through rollers and used in the production of baked or fried snack chips, unless the moisture content of the dough is adjusted by add back or by a partial drying.

Powdered meat, seafood, and/or poultry, used in the snack chips of the present disclosure, add animal protein to the snack chips herein, and have the potential to add a variety of interesting and marketable flavors without dramatically changing the overall look, feel and texture of the chips from traditional potato, corn, or tortilla chips.

In various embodiments, the snack chips of the present disclosure comprise wet dough components adding from about 20% by weight to about 70% by weight moisture to the dough, based on the total weight of the uncooked dough. Liquid dough components may include, but are not limited to, one or more of: water, milk, eggs, clarified butter, stock, liquors, juices, dough conditioners, chicken mash, turkey mash, duck, geese and/or quail mash, meat mash, seafood mash, mashed potatoes, liquid flavorings and extracts, liquid food colorings and liquid preservatives.

In various embodiments, the snack chips of the present disclosure comprise fat components at a level of from zero of up to about 20% by weight. As mentioned, conventional potato chips prepared by deep frying retain as much as 35% by weight fat. In various embodiments, the total fat content of the present snack chips may be less than about 10% by weight, or even less than about 5% by weight, based on the weight of the snack chip.

In various embodiments, the fat component may comprise any mixture of C₆ to C₂₆ free fatty acids and fatty acid mono-, di-, and tri-glycerides, having any degree of unsaturation in the fatty acid groups, and any combination of cis- or trans-orientation for the unsaturation that may be present. Fats for use in the snack chips of the present disclosure include any natural oils and fats, and any type of modified oils and fats. For example, snack chips in accordance with the present disclosure may comprise, but are not limited to, one or more of: canola oil, sunflower oil, safflower oil, grapeseed oil, soybean oil, olive oil, macadamia nut oil, flaxseed oil, sesame oil, rice bran oil, wheat germ oil, corn oil, cottonseed oil, peanut oil, almond oil, walnut oil, avocado oil, butter, ghee, lard, duck fat, chicken fat, goose fat, beef tallow, lamb tallow, coconut oil, palm oil, cocoa butter, margarine (stick, tub, or whipped), partially hydrogenated vegetable oils or shortening, fully hydrogenated vegetable oils or shortening, and mixtures thereof. Fats present in the snack chips of the present disclosure may be liquid or solid at room temperature.

Snack chips in accordance with the present disclosure may be flavored with any combination of food flavorings, such as for example, salt, sugar, vinegar, paprika, natural smoke, chives, sour cream, cumin, jalapeno, garlic, onion, molasses, cheese, pepper, and the like. Flavorings may be liquid, paste or solid, and may be added to dough used in preparing the snack chips of the present disclosure or added after the snack chips are baked and/or fried and prior to packaging. Flavors and texturing ingredients may be present in the snack chips of the present disclosure in powders, granulates, chunks or pieces. For example, pieces of fruit, nuts, corn, and the like, may be incorporated in the snack chips such that the chunks or pieces are visible. Dry powder ingredients, added to dough and/or onto the finished snack chips, may include, for example, herbs, milk solids, sour cream solids, spices, onion, garlic, paprika, ginger, hot red pepper, tomato, red bell pepper, sugar, artificial or natural sweeteners, flavorings and vitamins, and the like. These ingredients may be added to dough (during mixing or sprayed onto sheeted dough) at from about 0.1% to about 30% by weight, based on the weight of the uncooked dough. Any of the above-mentioned ingredients may be dispersed or dissolved in water or other carrier to facilitate addition to the dough or for spraying on sheeted dough. Alternatively, any of the above mentioned ingredients may be sprinkled onto the finished snack chips of the present disclosure at levels up to about 5% by weight based on the total weight of the snack chip.

Snack chips in accordance with the present disclosure may also include any combination of flavor enhancers, such as, for example, glutamic acid, monosodium glutamate, monopotassium glutamate, calcium diglutamate, monoammonium glutamate, magnesium diglutamate, guanylic acid, disodium guanylate, sodium guanylate, dipotassium guanylate, calcium guanylate, inosinic acid, disodium inosinate, dipotassium inosinate, calcium inosinate, calcium 5′-ribonucleotides, disodium 5′-ribonucleotides, maltol, ethyl maltol, glycine, sodium glycinate, L-leucine, and the like, and mixtures thereof.

Snack chips in accordance with the present disclosure may also comprise any combination of leavening agents, such as for example, baking powder, baking soda, and sour-dough starter, amongst others.

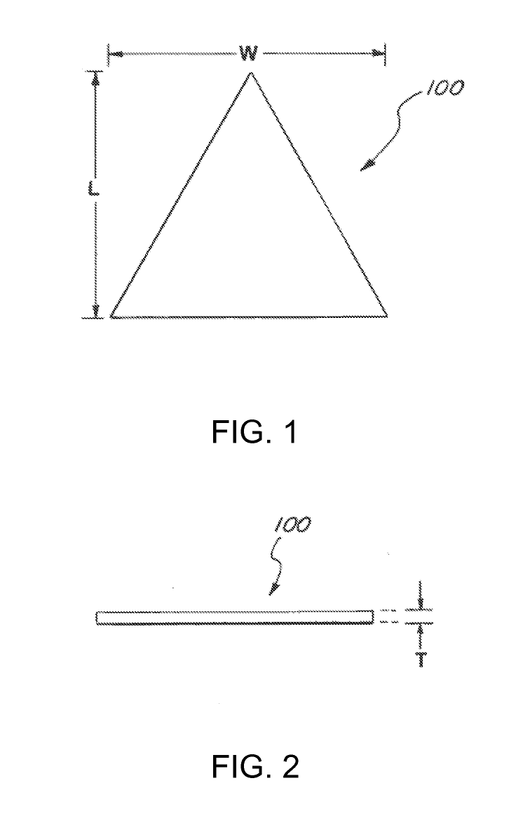

The above being noted, with reference now to FIG. 1, an embodiment of a snack chip 100 in accordance with the present disclosure is illustrated. The snack chip 100 illustrated here, and discussed in detail below, is a cooked chip (e.g. baked and/or fried). The snack chip 100 illustrated in FIG. 1 is triangular in shape. However, snack chips of the present disclosure may have any shape practical for a food snack, such as, for example, round, oval, square, rectangular, leaf, saddle (concave-convex), a concave shape, twisted strip or flat strip, or any other shape suitable for a snack food. For example, the snack chips of the present disclosure may be similar or identical in shape to various retail potato chips, corn chips or tortilla chips.

Snack chips in accordance with the present disclosure may be relatively smooth or textured, such as having a granulated (e.g. rough) appearance, and may comprise a “wavy” pattern, such as that found on Ruffles® Brand Potato Chips (from Frito-Lay North America, Inc.). The snack chip 100 may comprise blisters, wherein at least one side of the snack chip 100 has a thin cooked layer enclosing a small void. Blisters may appear as voids between layers in a snack chip 100 such that both sides of the snack chip 100 bulge around the small void in the chip. In various embodiments, each snack chip 100 may weigh about 0.1 to about 8 grams, and more preferably from about 0.3 to about 5 grams or from about 0.5 to about 3 grams.

With continued reference to FIG. 1, the snack chip 100 in accordance to the present disclosure can have, for example, a length “L” of from about 1 to about 8 cm, and, for example, a width “W” from about 1 to about 8 cm.

With reference now to FIG. 2, the snack chip 100 in accordance with the present disclosure may have a thickness “T” from about 2 to about 30 mm. In various embodiments, T may be from about 3 to about 10 mm. However, in other embodiments, the snack chips in accordance with the present disclosure can have any L, W, and T so long as the snack chip 100 remains consumable.

As discussed above, the snack chip 100, in accordance with the present disclosure, can comprise and combination of powdered dry meat, seafood, and/or poultry ingredients to increase the animal protein content of the snack chip 100, and/or to impart various meat, seafood and/or poultry flavors. Addition of such powdered, dry meat, seafood, and/or poultry can improve, for example, the nutritional value of the snack chip 100 over conventional potato chips. The snack chip 100 may comprise other flavorings that augment and/or complement the meat, seafood, and/or poultry flavors. For example, a snack chip 100, comprising roasted turkey powder, may also comprise cranberry flavoring to impart an overall roasted turkey/cranberry flavor to the chips. In various other embodiments, shrimp powder may be combined with crushed dried seaweed, sesame seeds and soy sauce flavors to create an Asian inspired, high protein, nutritional snack chip.

In various embodiments, the snack chip 100 can comprise, for example, an increased amount of protein from any combination of turkey mash, chicken mash or other poultry or meat mash added to the dough comprising traditional ingredients such as potato, corn, and/or rice. Other types of meat products may include, but are not limited to, beef, pork, and/or venison.

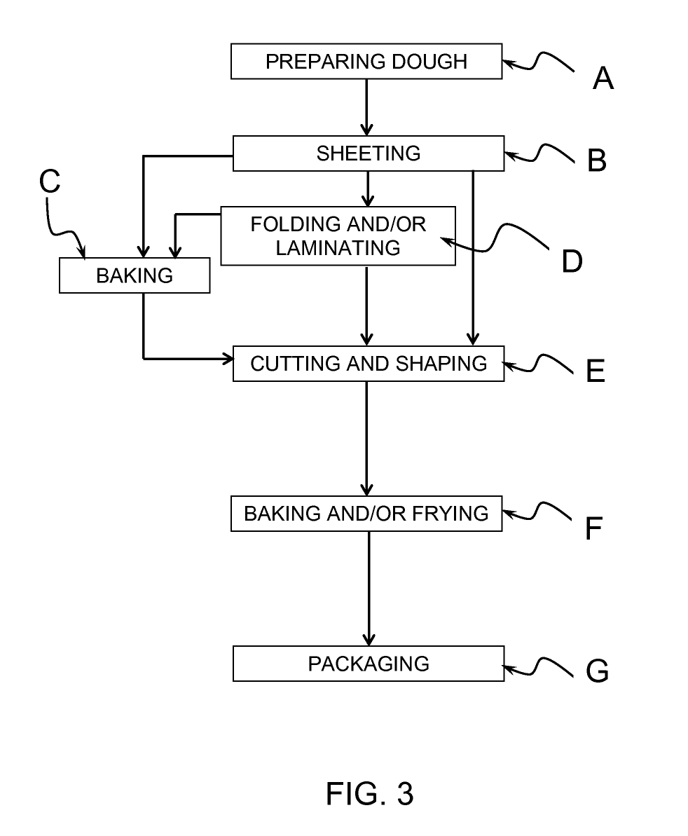

Referring now to FIG. 3, an embodiment of a method for preparing snack chips in accordance with the present disclosure is illustrated. In various embodiments, the method comprises certain combinations of any of the steps of: Step A, “Preparing Dough”; Step B, “Sheeting”; Step C, “Baking”; Step D, “Folding and/or Laminating”; Step E, “Cutting and Shaping”; Step F, “Baking and/or Frying”; and Step G, “Packaging.” Of these steps in the method illustrated, Steps C and D are optional, and Step E may comprise only cutting or stamping with no shaping of raw dough or baked dough. Step F may comprise only baking, only frying, or any sequence and number of baking and frying operations. Step G may comprise any type and size of packaging operation, for example, the loading of finished snack chips into bulk drums, totes, cartons, large bags, or individual snack food bags. In various embodiments, the product emerging from Step F of the method is the snack chip 100 as disclosed above.

In various embodiments, Step C, “Baking,” is an optional step wherein sheeted dough from Step B is first baked before cutting into chip-sized pieces and subsequent frying (Steps E and F). In various embodiments, the sequences of “A-B-D-C-E-F” or “A-B-C-E-F” are similar to production of tortilla chips. In various other embodiments, a sequence of A-B-D-C-E-F produces snack chips having the appearance and texture of blistered tortilla chips. In various embodiments, an additional “Cutting” step may be included between Step B “Sheeting” and Step C “Baking,” (not illustrated in FIG. 3). This optional cutting step may be used to cut sheeted dough into smaller sections that may be more practical for baking in Step C. Each step is discussed in more detail herein below.

In Step A (“Preparing Dough”), dough, suitable for use in preparing the present snack chips, can be prepared by combining and mixing various dry dough components, wet dough components, and optionally, fat components. For example, dough may comprise any combination of potato, corn, wheat, and/or rice flours, starches or meals, dry powdered meat, seafood, and/or poultry, turkey and/or chicken mash, other poultry products such as duck, geese, and/or quail mash, mashed potatoes, grains, seeds, yeast, baking soda, baking powder, salt, sugar, syrup, water, milk, eggs, clarified butter, melted butter and/or other fats, stock, liquors, juices, dough conditioners, flavors, flavor enhancers, preservatives, coloring and any other food ingredients typically used in dough.

Apparatus suitable for Step A can include any number of devices configured to add and mix dry, wet, and optional fat ingredients into workable dough capable of being sheeted. Such devices include, but are not limited to, vessels, chutes, conveyors, motors, electrical wiring, paddles, hooks, blades, beaters, arms, housings, insulation, heaters, coolers, temperature regulators, spray nozzles, and the like.

In various embodiments, dough may comprise about 20-70% by weight moisture, and more preferably 35-70% by weight or 45-65% by weight moisture, based on the total weight of the uncooked dough. In another embodiment, the dough comprises 50-65% by weight moisture, based on the total weight of the uncooked dough. If the dough is too wet, the dough may tend to stick to rollers used in the sheeting process (described below).

Total moisture in the uncooked dough may derive, for example, from a combination of wet dough components such as water, syrups, milk, eggs, clarified butter, stock, liquors, juices, turkey mash, chicken mash, and/or other poultry, meat or seafood mash, mashed potatoes or other cooked, mashed or pureed vegetables, dough conditioners, liquid flavorings and extracts, liquid food colorings and liquid preservatives.

In various embodiments, the protein content of dough used to prepare the snack chips of the present disclosure can be about 3% by weight or higher, based on the total weight of the dough, from incorporation of meat, seafood and/or poultry powder, and/or meat, seafood and/or poultry mash in the dough.

In various embodiments, the dry dough components and/or the wet dough components can comprise 30-100% by weight of the dough. In one embodiment, for example, the wet dough components can comprise 30-100% by weight of the dough. In various embodiments, dough can comprise about 30% to about 100% by weight wet dough components of turkey or chicken. The increased usage of turkey and/or the chicken over the corn, the rice, and/or the potato, can increase the taste and consumer appeal of the snack chip 100. This can be particularly true if the turkey and/or the chicken are low in fat and/or have pleasant, non-bitter poultry taste. In one embodiment, for example, fresh 99% fat free turkey and/or chicken breast is/are used for the turkey and/or the chicken, respectively. Furthermore, the increased usage of turkey and/or chicken can improve the protein content of the dough and, ultimately, the snack chip 100.

However, turkey, chicken, or other mash ingredients may contain a moisture content of approximately 80% by weight, based on the total weight of the mash, and use of these ingredients may result in dough that is too moist and prone to sticking to rollers used in the sheeting process. In various embodiments, dough that becomes too moist from the use of mash ingredients may be reduced in moisture to reduce or prevent sticking to the rollers. In other embodiments, the dough and/or the rollers may be treated with non-stick substances, and/or the dough and/or the rollers may be cooled to reduce or prevent sticking of the dough to the rollers. In various embodiments, to ensure that the dough has the proper moisture content, a balancing of the wet dough components, including the turkey and/or chicken mash, with the dry dough components, such as the corn, wheat, rice, and/or potato flour and/or starches, can be performed. In other embodiments, powdered and dry meat, seafood, and/or poultry ingredients may be used to partially or fully replace the turkey and/or chicken mash or other mash ingredients in the dough.

In various embodiments, moisture can be removed, for example, from the turkey mash or the chicken mash through moisture reducing steps, such as partial drying. If the dough contains some oils or fats, further reduction of moisture content may be needed in order to achieve good, machinable dough. In additional embodiments, dry ice can also be added to the dough to cool it during processing. This reduction in temperature can help reduce the stickiness of the dough and reduce the likelihood of the dough sticking to one or more rollers used to flatten the dough.

In various embodiments, an “add back” process may be used in which cooked turkey or cooked chicken is reduced in moisture by adding back enough previously dried granules to produce a sufficiently dry yet moist mix, which after holding can be satisfactorily granulated to a fine powder. The fine powder can also include emulsifiers, anti-oxidants, colorants, and/or flavors.

In various embodiments, dough used in preparing the snack chips of the present disclosure is “masa.” “Masa” herein refers to dough prepared from hominy. Hominy (or posole) is whole corn that has been nixtamalized. For producing masa, it may only be necessary to add fresh masa into a dough mixer and to work the masa sufficiently long to produce smooth dough. In various embodiments, additional water, stock or other liquids may be added to fresh masa to produce a final masa capable of being sheeted. In various embodiments, masa flour, lard and/or shortening, and water and/or chicken, beef, and/or vegetable stock, may be combined in Step A to produce masa. For example, Minsa® or Maseca® brand masa mix may be used as the flour herein. In various embodiments, masa flour, combined with any other dry dough ingredient(s) discussed herein, can be mixed with any combination of wet dough and fat ingredient(s) discussed herein to make versions of masa useful in the preparation of the snack chip 100.

In various embodiments, masa flour may be mixed with meat, seafood and/or poultry powder at a ratio of about 1:1 to create a dry dough ingredient mix. Blue masa and/or conventional yellow masa flour may be mixed with any combination of dry, wet, and fat dough components to prepare dough usable in the preparation of the snack chip 100. In exemplary embodiments, masa is prepared from turkey powder, blue or yellow masa flour, water and/or stock, and optionally, shortening and/or lard. The turkey powder/masa flour weight ratio may be, for example, about 1:1.

Other ingredients that may be incorporated in dough used for the production of snack chips in accordance with the present disclosure include, for example, vegetable matter in the form of a dry powder or a puree. Vegetable matter may include, but is not limited to, any one or more of: herbs, spices, onion, tomato powder or puree, red bell pepper powder or puree, or any other types of vegetable powder or puree material.

Other ingredients may include, but are not limited to, one or more of: oils, salt, sugar, sweeteners, flavorings, vitamins and/or supplements, included at from about 0.1 to about 60% by weight, based on the total weight of the uncooked dough. Oil may, for example, help prevent the dough from sticking to sheeting rollers. Dough can include, for example, 0.1 to 5% by weight salt, and/or 10% by weight sugar or other sweeteners, based on the total weight of the uncooked dough. The vitamins and/or supplements can increase, for example, the nutritional content of the snack chip 100. The other ingredients may be incorporated into the dough prior to forming. In one embodiment, part or all of the other ingredients can be incorporated into the dough while the dough is “fresh dough.” In other embodiments, part of all of the other ingredients can be incorporated into the dough after shaping and prior to cooking (e.g. frying and/or baking)

Furthermore, the other ingredients can optionally be incorporated using a carrier, dispersant or sticking agent, such as, water, oil, emulsion, or other types of materials. A browning or seasoning agent may be sprayed onto particles of the other ingredients using the dispersion agent. In one embodiment, such as when the other ingredients comprise herbs, salt, spices, seasonings or flavors, the ingredients can be sprayed onto the sheeted dough, the pieces cut from the dough, and/or the finished snack chips, as a solution or dispersion in water, oil, or an oil/water emulsion.

With continued reference to FIG. 3, a method for producing snack chips in accordance with the present disclosure comprises Step B, (“Sheeting”), which is the step of rolling or otherwise flattening dough into thin sheets. In various embodiments of the present method, dough is sheeted to a thickness of approximately 0.05 mm to 1 mm. In one embodiment, dough is preferably between 0.05 mm and 0.6 mm thick. In another embodiment, the dough is preferably sheeted to between 0.1 mm to 0.6 mm thick. In yet another embodiment, the dough is preferably sheeted to between 0.1 mm to 0.4 mm thick. However, the dough can be flattened to any thickness that produces a finished snack chip that a consumer can eat. The flattening of the dough used to make the present snack chips can be achieved through any suitable sheet-forming means now known or hereinafter discovered.

In various embodiments of Step B of the present method, dough can be extruded, pressed through a die, and/or rolled into sheets using one or more rollers. Apparatus to carry out Step B includes various devices configured for sheeting dough, including for example, extruders, dies, rollers, presses, stamps and cutter rollers. Rollers may be treated with non-stick coatings, and temperature regulation, such as cooling, may be used as necessary during the sheeting step. Rollers may be entirely flat and smooth, or may be textured or comprise notches or other surface modifications such that a desired pattern is pressed into the dough during sheeting. For example, evenly spaced circumferential grooves in sets of rollers can be configured to produce wave patterns in the sheeted dough.

With continued reference to FIG. 3, an embodiment of the method for preparing snack chips is accordance with the present disclosure may include the optional baking Step C, “Baking” As discussed above, this baking step may be used to pre-bake sheeted dough into “tortillas” that can be subsequently cut into pieces and baked and/or fried into tortilla chips. Apparatus suitable for optional Step C may include furnaces or ovens, either being gas, electric, wood, charcoal or coal fired, for example.

A method for producing snack chips in accordance with the present disclosure may comprise optional Step D, (“Folding/Laminating”), which is the step in the present method where dough can be loosely folded and/or loosely partly laminated for texturing effects, such as blisters (trapped air pockets fried into blisters).

A method for producing snack chips in accordance with the present disclosure comprises Step E, (“Cutting/Shaping”), which is the step wherein previously sheeted dough is cut into pieces, each piece being the precursor to an individual snack chip 100. Step E may include cutting and optionally shaping of either raw dough (from Step B), folded and/or laminated sheeted raw dough (from Step D), or dough previously baked in Step C. The Cutting Step E may comprise cutting dough into individual dough pieces that are each approximately the shape and size of a single finished snack chip.

With reference still to FIG. 3, a method for producing snack chips in accordance with the present disclosure comprises Step F, “Baking and/or Frying,” which is the step in the method wherein previously cut and raw dough, or previously baked and cut dough, is now baked and/or fried into the finished snack chips. As mentioned, Step F may comprise only baking, only frying, or combinations of the two cooking operations. Step F may be accomplished by way of ovens, furnaces or fryers such as deep fat fryers.

In various embodiments, a method for producing snack chips in accordance with the present disclosure optionally comprises Step G, “Packaging.” As discussed above, packaging can be in bulk for wholesale distribution and sales or may be as small as individual servings. In various embodiments, snack chips 100 are packed into bags or other suitable containers such that the chips are not overly compressed. Overly compressed snack chips 100 may crush one another, particularly at the delicate thin blisters on the chips. Bags may be laminated foil and plastic, or any other suitable material, and may be heat sealed after filling.

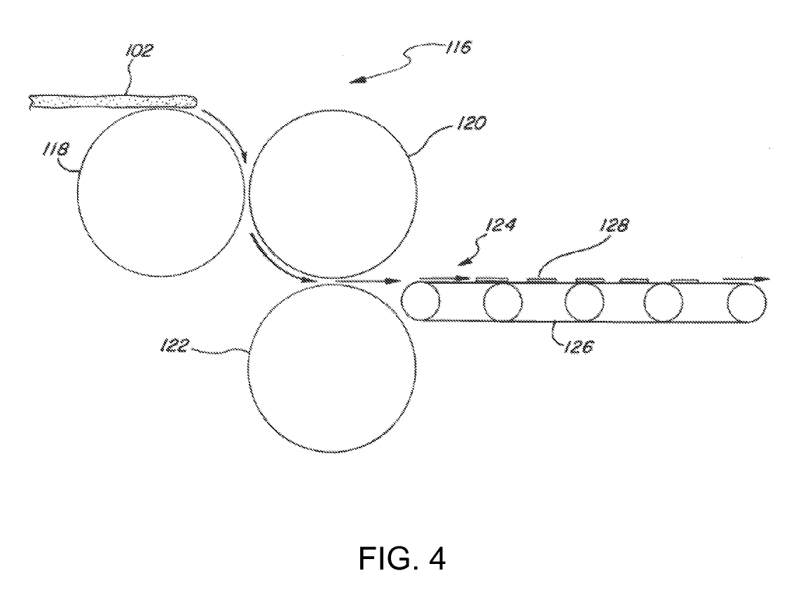

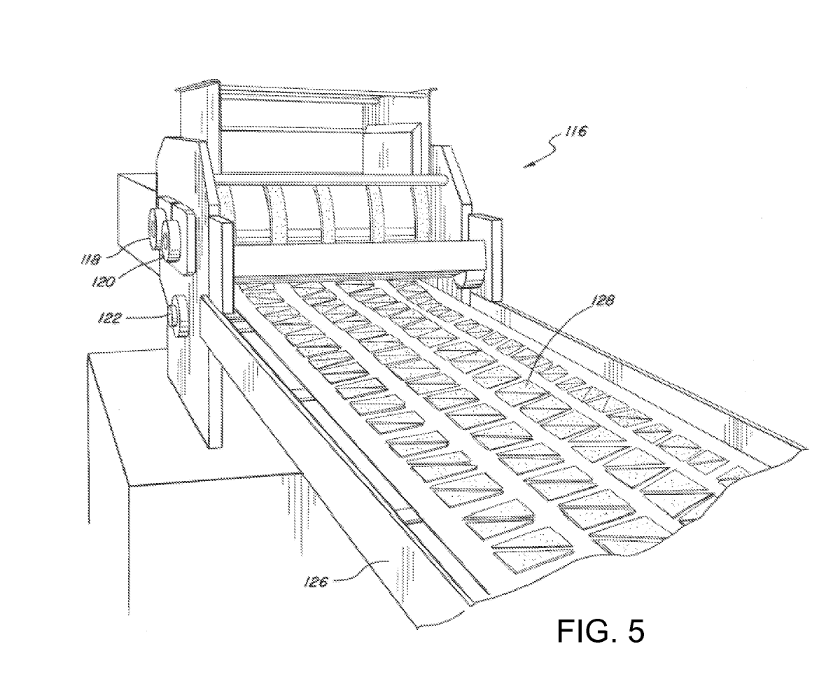

FIGS. 4 and 5 illustrate embodiments of a dough processor configured to sheet and cut and optionally laminate and shape dough for preparing the snack chips of the present disclosure. Such processing machines are available, for example, from Richmond Industrial Machine Inc., Augusta, Ga., amongst other suppliers. With reference to both FIGS. 4 and 5, dough 102 is fed through the dough processor 116 in a direction 124. The dough processor 116 can include, for example, a roller 118, a roller 120, a cutter roller 122, and a conveyor 126. The dough 102 can be fed though the rollers 118 and 120 to form sheeted dough from dough 102. Sheeted dough passing through cutter roller 122 can then emerge onto conveyor 126 in the form of cut dough pieces 128. The dough may be cut into any shape desired by the cutter roller to produce snack chips having the shapes discussed previously. The rollers 118 and 120 can extrude the dough 102 with pressure sufficiently high enough to flatten the dough 102 yet sufficiently low enough to prevent the dough 102 from becoming too firm or acquiring too hard a texture. Although rollers are illustrated in this particular embodiment for sheeting dough, any other device(s) capable of flattening or extruding dough, without the dough becoming too firm or acquiring too hard a texture, may be used for the sheeting step.

In various embodiments, dough pieces 128 can be formed by a stamping process rather than a cutting process. In other embodiments, sheeted dough emerging from the roller 118 and 120 may be pressed into individual molds, each mold having the dimensions appropriate for a single chip, such as an equilateral triangle shape of about 3 to 20 cm on each edge and a depth of the mold of about 0.5 to 2 cm. The molds can be, for example, gutter or trough shaped and may run perpendicular to the moving conveyor belt 126. Molds may be coated with polytetrafluoroethylene (PTFE), also known as Teflon® by DuPont, to prevent the dough from sticking in the molds. The molded and shaped dough may then be ejected from the molds prior to cooking of the dough pieces, or alternatively the molds can be directly inserted into an oven or fryer and the chips cooked in their molds.

In various embodiments, the dough sheet of the dough 102 can be loosely folded and/or loosely partly laminated after exiting the rollers 118 and 120. Thus, after exiting the rollers 118 and 120, the sheeted dough from dough 102 may not be a completely flat but rather partially layered and/or curved. Laminations are likely held together by stickiness inherent in dough created from ingredients such as corn, rice and/or potato. The lamination of dough (Step D of FIG. 3) offers a way to create “blisters” in the cooked snack chip 100. These blisters are created from air pockets trapped between the layers of dough when the dough is laminated. The trapped air expands and puffs out on a portion of the chip during the baking or frying of the chips (e.g. in Step F of the illustrated method in FIG. 3). Blisters on cooked chips may comprise layers as thin as about 0.05 mm to about 1 mm, and in some cases, from about 0.05 mm to about 0.6 mm, or between about 0.1 mm to about 0.4 mm.

Although the rollers 118 and 120 can loosely fold and/or loosely partially laminate sheeted dough, in another embodiment, the rollers 118 and 120 can feed the dough into a transport unit such as a conveyor belt. The speeds of the rollers and the conveyor can be adjusted to lead or lag one another such that the sheeted dough loosely folds or loosely laminates. This can be achieved, for example, when the ratio of the speed of the dough leaving the rollers 118 and 120 to the speed of the transport unit is roughly between about 100:1 and 3:1, and preferably from about 50:1 and about 5:1.

In various embodiments, the rollers 118 and 120, and/or the cutter roller 122, can be chilled to lower temperatures to prevent the dough 102 from sticking to the rollers 118 and 120 and/or the cutter roller 122, which may be caused by particular moisture levels in the dough 102. For example, high moisture content in the dough 102, and dough sticking to the rollers, may be the results of various wet dough components, such as for example, turkey, chicken and/or other poultry mash. To reduce sticking, the rollers 118 and 120 and/or the cutter roller 122 can also be coated with non-stick materials such as polytetrafluoroethylene (PTFE), also known as Teflon® by DuPont, to prevent the dough 102 from sticking to the rollers 118 and 120 and/or the cutter roller 122 due to the moisture content in the dough 102.

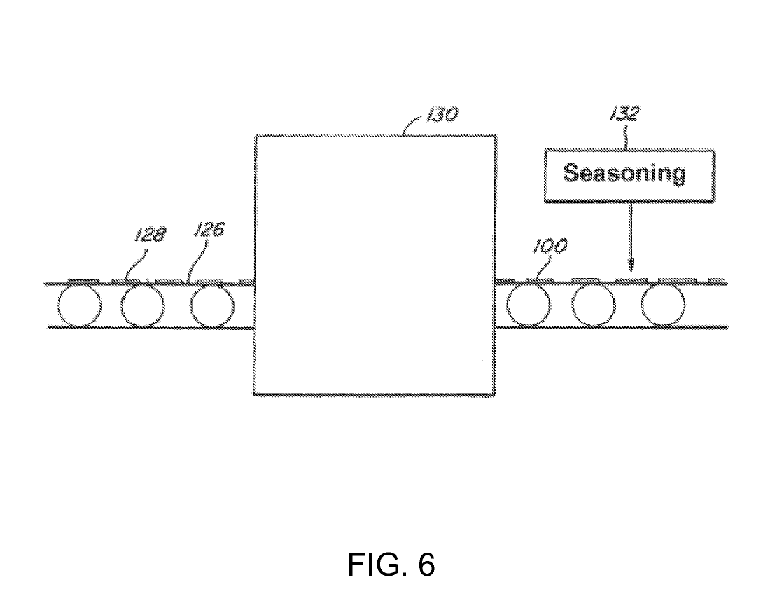

Referring now to FIG. 6, an oven or furnace is illustrated that can be used for the optional Step C, “Baking,” and/or for the final cooking Step F, “Baking and/or Frying.” In the furnace illustrated in FIG. 6, raw or previously baked dough pieces 128, cut and/or shaped into the shape desired for the snack chip 100, are fed into furnace 130 by a conveyor belt 126. The furnace 130 can include, for example, wood and/or charcoal fire, heat lamps, ultraviolet lamps, resistive heaters, hot air blowers, or any other types of devices that can be used to reduce the moisture content of the dough as the dough is cooked into snack chips.

The furnace 130 can reduce the moisture content in the final snack chip 100 to about 0-8% by weight, preferably 0-6% by weight, based on the total weight of the cooked snack chip 100. As mentioned, lamination and/or folding can create desired blisters on the snack chips 100. The furnace 130, or multiple furnaces, can dry the dough pieces 128 in multiple stages rather than in a single stage. For example, in a first drying stage, furnace 130 can have an internal temperature of between about 80-160° C. and preferably between about 90-130° C. Then, in a second drying stage, the furnace 130 can have a temperature of between about 60-100° C. and preferably between about 60-90° C., in order to reduce the moisture level in the final cooked snack chip to about 0-8% by weight, based on the total weight of the cooked chip.

In various embodiments, the dough pieces 128 may be cooked in a furnace, such as furnace 130, at temperatures up to about 140° C., 160

° C., or 300° C. These temperatures may be used in any stage of a multiple stage baking operations. In other embodiments, baking may be accomplished at temperatures below about 100° C., such as between about 60° C. and 100° C., or 75° C. to 100° C. However, at these low baking temperatures, the snack chips 100 may end up with a bleak and unappealing color. In the cooking process (Step F in FIG. 3), seasoning 132 may be added to the snack chips 100 after cooking or to the dough pieces 128 prior to cooking.

As discussed, when Step F of FIG. 3 comprises a frying operation, a deep-fryer, auto-continuous conveyor fryer, an expeller pressed oil deep-fryer, or other suitable commercial fryer, can be used in place of, or in addition to, a furnace. A fryer can be used in a similar manner to cook raw dough pieces, or to finish cooking previously baked sheeted dough cut into pieces for the fryer, such that the moisture content is reduced without dramatically increasing the fat content of finished snack chips 100. Any suitable oil and/or shortening can be used in a fryer for Step F of FIG. 3. In various other embodiments, the dough pieces 128 can be air dried, gradually dried, and/or flash dried into snack chips 100.

In various embodiments, snack chips 100 will have a different composition (in wt. percentages) and appearance from the uncooked dough, due primarily to (a) the reduction in overall moisture content of the dough during the baking and/or frying operation(s); (b) the incorporation of fats into the chip when the dough pieces are cooked; and (c) a browning of the dough pieces that, in various embodiments, results in a golden colored snack chip. In various embodiments, for example, the snack chip 100 can have a fat content of between about 0-20% by weight, and preferably 0.1-20% by weight, 0.1-10% by weight, or 0.1-5% by weight, based on the total weight of the snack chip 100.

The final cooking process of baking and/or frying produces a tasty, reduced fat, crispy, crunchy snack chip having a high amount of protein from animal sources. The snack chips of the present disclosure give a crispy feeling in the mouth, breaking easily upon eating without a feeling that the chips are too hard. In various embodiments, the snack chips have a consumer recognizable shape, such as triangular, blisters comprising crispy thin layers, and a structural stability to allow for the packaging of a plurality of chips in a bag without excessive breakage of the chips. In various embodiments, the chips retain crispiness. In various embodiments, the snack chips have a shelf life when packaged of a least a month. The snack chips of the present disclosure provide a healthy snack alternative to conventional potato chips while retaining the shape, sensation and typical flavors of conventional potato chips.

It will be apparent to those skilled in the art that various modifications and variations can be made in the present disclosure without departing from the spirit or scope of the disclosure. Thus, it is intended that the present disclosure cover the modifications and variations of this disclosure provided they come within the scope of the appended claims and their equivalents.

What is claimed is:

1. A cooked snack chip comprising:
at least one of dry powdered meat, seafood, and poultry; and
at least one of flour and starch,
wherein said chip comprises at least 3% by weight animal-sourced protein, and from about 0% to about 8% by weight moisture content, based on the total weight of said cooked snack chip.

2. The cooked snack chip of claim 1, wherein said flour is wheat.

3. The cooked snack chip of claim 1, wherein said flour is rice.

4. The cooked snack chip of claim 1, wherein said flour is corn.

5. The snack chip of claim 1, wherein said starch comprises potatoes.

6. A method for preparing a high protein snack chip, said method comprising:
(a) preparing a dough, said dough comprising at least one dry dough component; at least one wet dough component; and, optionally, at least one fat component;
(b) sheeting said dough into sheeted dough having a thickness of from about 0.5 mm to about 1 mm;
(c) cutting said sheeted dough into dough pieces;
(d) cooking said dough pieces into said high protein snack chips, said high protein snack chips having at least 3% by weight animal-sourced protein, and a moisture content of from about 0% to about 8% by weight, based on the total weight of the high protein snack chip.

7. The method of claim 6, wherein said at least one dry dough component comprises at least one of dry powdered meat, dry powdered seafood, and dry powdered poultry.

8. The method of claim 6, wherein said at least one wet dough component comprises at least one of meat mash, seafood mash, and poultry mash.

9. The method of claim 6, wherein said at least one wet dough component comprises cooked and mashed potatoes.

10. The method of claim 6, wherein said dough is masa.

11. The method of claim 6, wherein said at least one dry dough component is selected from the group consisting of corn flour, wheat flour, rice flour, oat flour, mesquite bean flour, and mixtures thereof.

12. The method of claim 6, further comprising a baking step wherein said sheeted dough is baked prior to cutting into said dough pieces.

13. The method of claim 6, wherein said cooking is baking in an oven or furnace.

14. The method of claim 6, wherein said cooking is frying in oil or shortening.
